(19) United States
(12) Patent Application Publication
(10) Pub. No.: US 2014/0254773 A1
(43) Pub. Date: Sep. 11, 2014

(54) EMERGENCY CALLING TECHNIQUES

(71) Applicant: Bandwidth.com, Inc., Raleigh, NC (US)

(72) Inventors: Larry Reeder, Denver, CO (US); Kevin Breault, Denver, CO (US)

(73) Assignee: Bandwidth.com, Inc., Raleigh, NC (US)

(21) Appl. No.: 14/285,001

(22) Filed: May 22, 2014

(51) Int. Cl. H04M 11/04

(52) U.S. Cl. CPC H04M 11/04
USPC 379/45

(57) ABSTRACT

Embodiments of the invention provide systems and methods for handling emergency calls. According to one embodiment, handling an emergency call can comprise receiving an emergency call from a calling number, determining whether the calling number has been ported from an original geographic location to a new geographic location, determining a spatial location for the calling number based at least in part on whether the calling number has been ported, identifying a public safety system for handling the emergency call based on the determined spatial location for the calling number, and routing the emergency call to the identified public safety system. Identifying the public safety system for handling the emergency call can comprise using a point-in-polygon check of the determined spatial location for the calling number against known spatial boundaries for a plurality of public safety systems.

### BACKGROUND OF THE INVENTION

Embodiments of the present invention relate generally to methods and systems for handling emergency calls and more particularly to routing of emergency calls that do not have a physical address associated with a phone number from which the call originates and/or when the phone number has been ported from a different geographic location.

Emergency calls placed to 9-1-1 from a fixed landline may be routed to a proper public safety system such as a dispatcher for local fire or police agencies based on a known physical location at which the landline is installed. However, the phone numbers associated with these landlines may be ported to a new location, for example when a person moves to a new home. In such cases, the previously known location is no longer valid, at least until it can be updated. Furthermore, even a rough geographic location associated with the number may be difficult to determine from the number itself since the number may be ported from an entirely different local exchange area or even area code making routing of the emergency call based on this information alone ineffective. Hence, there is a need for improved methods and systems for handling emergency calls.

### BRIEF SUMMARY OF THE INVENTION

Embodiments of the invention provide systems and methods for handling emergency calls. According to one embodiment, handling an emergency call can comprise receiving an emergency call from a calling number, determining whether the calling number has been ported from an original geographic location to a new geographic location, determining a spatial location for the calling number based at least in part on whether the calling number has been ported, identifying a public safety system for handling the emergency call based on the determined spatial location for the calling number, and routing the emergency call to the identified public safety system. Identifying the public safety system for handling the emergency call can comprise using a point-in-polygon check of the determined spatial location for the calling number against known spatial boundaries for a plurality of public safety systems.

Prior to receiving an emergency call, a spatial location of each of a plurality of telephone network switches can be registered. Registering the spatial location of each of the plurality of telephone network switches can comprise determining a spatial location for each of the plurality of telephone network switches based on a known physical location and storing the spatial location for each of the plurality of telephone network switches. Determining the physical location can comprise using an NPA-NXX number for each switch to look up a known physical location for the switch. Converting the determined physical location of each of the plurality of telephone network switches to a spatial location can comprise converting the physical location of each switch to a set of latitude-longitude coordinates. Storing the spatial location for each of the plurality of telephone network switches can comprise storing the set of latitude-longitude coordinates, the NPA-NXX number, and a switch identifier for each switch.

Determining whether the calling number has been ported can comprise querying a database of routing numbers using the calling number. When the querying a database of routing numbers using the calling number returns a routing number associated with the calling number, the calling number can be determined to be ported. When the querying a database of routing numbers using the calling number does not return a routing number associated with the calling number, the calling number can be determined to not be ported. Querying the database of routing numbers can comprise using an Automatic Number Identification (ANI) number of the calling number to look up a Local Routing Number (LRN) for the calling number.

In response to determining the calling number has been ported, determining the spatial location for the calling number can further comprises identifying a telephone network switch associated with the calling number using the routing number and retrieving the registered spatial location for the identified switch associated with the calling number. In response to determining the calling number has not been ported, determining the spatial location for the calling number can further comprise determining a physical location for a telephone network switch associated with the emergency call and converting the determined physical location of the telephone network switch associated with the emergency call to a spatial location. In such cases, determining the physical location can comprise using an NPA-NXX number for the calling number to look up a known physical location for the telephone network switch associated with the emergency call. Converting the determined physical location of the telephone network switch associated with the emergency call to a spatial location can comprise converting the physical location for the telephone network switch associated with the emergency call to a set of latitude-longitude coordinates.

### BRIEF DESCRIPTION OF THE DRAWINGS

FIG. 1 is a block diagram illustrating components of an exemplary operating environment in which various embodiments of the present invention may be implemented.

FIG. 2 is a block diagram illustrating an exemplary computer system in which embodiments of the present invention may be implemented.

FIG. 3 is a block diagram illustrating elements of an exemplary environment in which emergency call handling may be performed and in which embodiments of the present invention may be implemented.

FIG. 4 is a flowchart illustrating a process for handling an emergency call according to one embodiment of the present invention.

FIG. 5 is a flowchart illustrating an exemplary process for registering a spatial location for a telephone network switch according to one embodiment of the present invention.

FIG. 6 is a flowchart illustrating an exemplary process for determining whether a calling number making an emergency call has been ported according to one embodiment of the present invention.

FIG. 7 is a flowchart illustrating an exemplary process for determining a spatial location for a calling number making an emergency call according to one embodiment of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

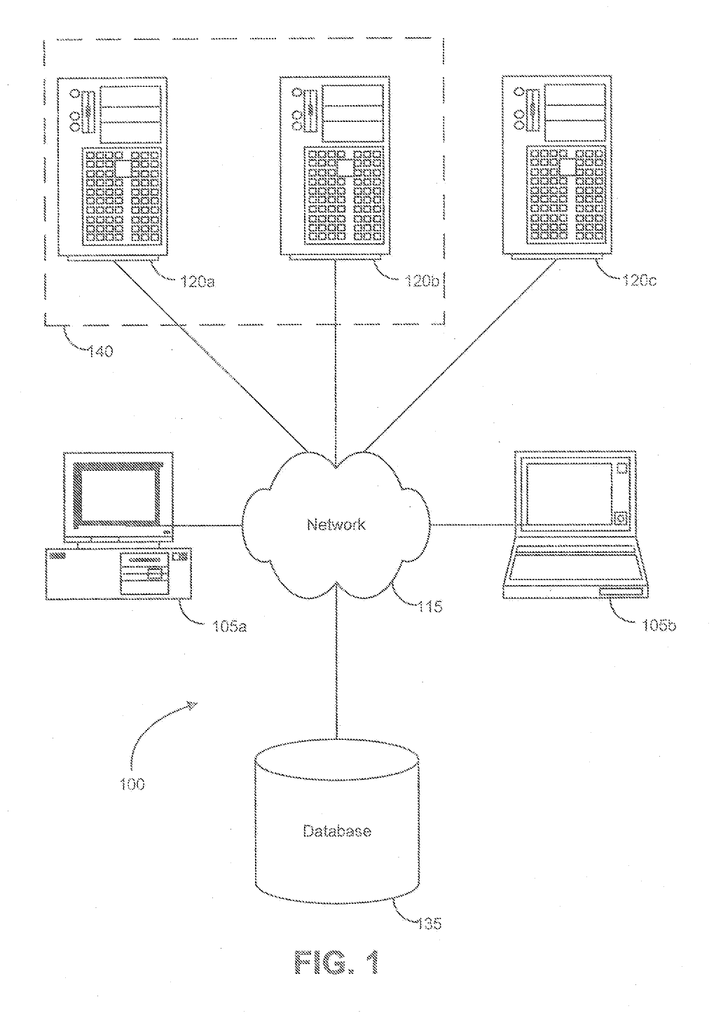

FIG. 1 is a system block diagram illustrating components of an exemplary operating environment in which various embodiments of the present invention may be implemented. The system 100 may include one or more user computers 105a-b which may be used to operate a client, whether a dedicated application, web browser, etc. The user computers 105a-b may be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, a variety of GNU/Linux operating systems). These user computers 105, 110 may also have any of a variety of applications, including one or more development systems, database client and/or server applications, and web browser applications. Alternatively, the user computers 105a-b may be any other electronic device, such as a thin-client computer, Internet-enabled mobile telephone, and/or personal digital assistant (PDA), capable of communicating via a network (e.g., the network 115 described below) and/or displaying and navigating web pages or other types of electronic documents. Although the exemplary system 100 is shown with two user computers, any number of user computers may be supported.

In some embodiments, the system 100 may also include a network 115. The network 115 may be any type of network familiar to those skilled in the art that may support data communications using any of a variety of commercially-available protocols, including without limitation TCP/IP, SNA, IPX, AppleTalk, and the like. Merely by way of example, the network 115 may be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system 100 may also include one or more server computers 120a-c which may be general purpose computers and/or specialized server computers (including, merely by way of example, PC servers, UNIX servers, mid-range servers, mainframe computers rack-mounted servers, etc.). One or more of the servers (e.g., 120) may be dedicated to running applications, such as a business application, a web server, application server, etc. Such servers 120 may be used to process requests from user computers 105. The applications may also include any number of applications for controlling access to resources of the servers 120.

A web server may run an operating system including any of those discussed above, as well as any commercially-available server operating systems. The web server may also run any of a variety of server applications and/or mid-tier applications, including HTTP servers, FTP servers, CGI servers, database servers, Java servers, business applications, and the like. The server(s) 120 also may be one or more computers that may be capable of executing programs or scripts in response to the user computers 105, 110. As an example, a server 120 may execute one or more web applications. A web application may be implemented as one or more scripts or programs written in any programming language, such as Java™, C, C# or C++, and/or any scripting language, such as Perl, Python, or TCL, as well as combinations of any programming/scripting languages. The server(s) 120 may also include database servers, including without limitation those commercially available from Oracle®, Microsoft®, Sybase®, IBM® and the like, which may process requests from database clients running on a user computer 105.

In some embodiments, an application server may create web pages dynamically for displaying on an end-user (client) system. The web pages created by the web application server may be forwarded to a user computer 105 via a web server. Similarly, the web server may receive web page requests and/or input data from a user computer and may forward the web page requests and/or input data to an application and/or a database server. Those skilled in the art will recognize that the functions described with respect to various types of servers 120 may be performed by a single server and/or a plurality of specialized servers, depending on implementation-specific needs and parameters.

The system 100 may also include one or more databases 135. The database(s) 135 may reside in a variety of locations. By way of example, a database 135 may reside on a storage medium local to (and/or resident in) one or more of the computers 105 or servers 120. Alternatively, it may be remote from any or all of the computers 105 or servers 120, and/or in communication (e.g., via the network 115) with one or more of these. In a particular set of embodiments, the database 135 may reside in a storage-area network (“SAN”) familiar to those skilled in the art. Similarly, any necessary files for performing the functions attributed to the computers 105 or servers 120 may be stored locally on the respective computer and/or remotely, as appropriate. In one set of embodiments, the database 135 may be a relational database, such as Oracle 10g, that is adapted to store, update, and retrieve data in response to SQL-formatted commands.

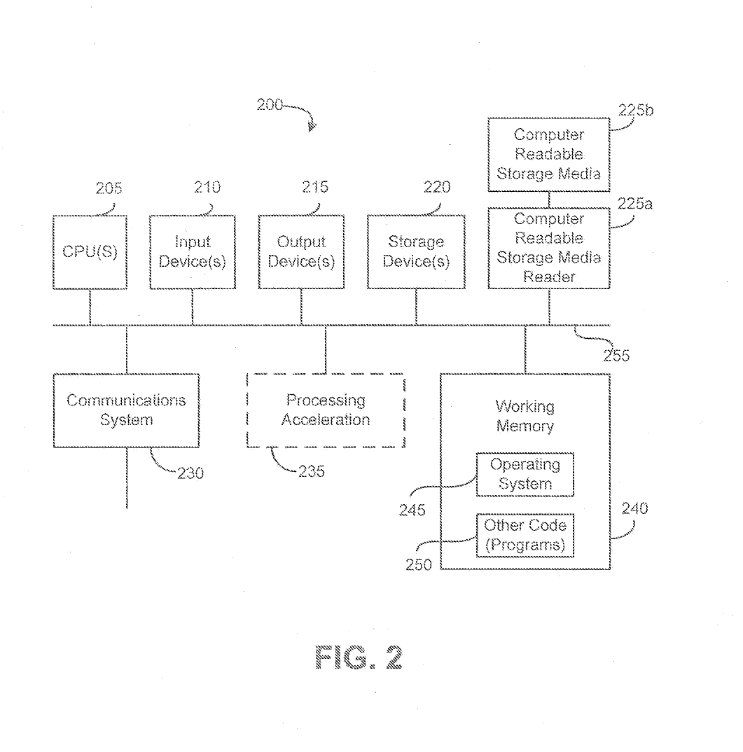

FIG. 2 illustrates an exemplary computer system 200, in which various embodiments of the present invention may be implemented. The computer system 200 may be used to implement any of the systems 100 described above. The computer system 200 is shown comprising hardware elements that may be electrically coupled via a bus 255. The hardware elements may include one or more central processing units (CPUs) 205, one or more input devices 210 (e.g., a mouse, a keyboard, etc.), and one or more output devices 215 (e.g., a display device, a printer, etc.). The computer system 200 may also include one or more storage devices 220. By way of example, storage device(s) 220 may be disk drives, optical storage devices, solid-state storage device such as a random access memory (“RAM”) and/or a read-only memory (“ROM”), which may be programmable, flash-updateable and/or the like.

The computer system 200 may additionally include a computer-readable storage media reader 225a, a communications system 230 (e.g., a modem, a network card (wireless or wired), an infra-red communication device, etc.), and working memory 240, which may include RAM and ROM devices as described above. In some embodiments, the computer system 200 may also include a processing acceleration unit 235, which may include a digital signal processor (DSP), a special-purpose processor and/or the like.

The computer-readable storage media reader 225a may further be connected to a computer-readable storage medium 225b, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with the network 115 and/or any other computer 105 or server 120 described above with respect to the system 100.

The computer system 200 may also comprise software elements, shown as being currently located within working memory 240, including an operating system 245 and/or other code 250, such as an application program (which may be a client application, web browser, mid-tier application, RDBMS, etc.). It should be appreciated that alternate embodiments of computer system 200 may have numerous variations from that described above. For example, customized hardware may also be used and/or particular elements may be implemented in hardware, software (including portable software, such as applets), or both. Further, connection to other computing devices such as network input/output devices may be employed. Software of computer system 200 may include code 250 for implementing embodiments of the present invention as described herein.

For example, any of the networks, servers, and/or computer described above may be utilized to implement an emergency calling system in which embodiments of the present invention may be implemented. Embodiments of the present invention may be directed to routing and other handling of emergency calls, e.g., 911 calls. More particularly, embodiments of the present invention are directed to routing of emergency calls that do not have a physical address associated with a phone number from which the call originates and/or when the phone number has been ported from a different geographic location such as when a person moves to a new home and ports an existing phone number from the previous home to the new home.

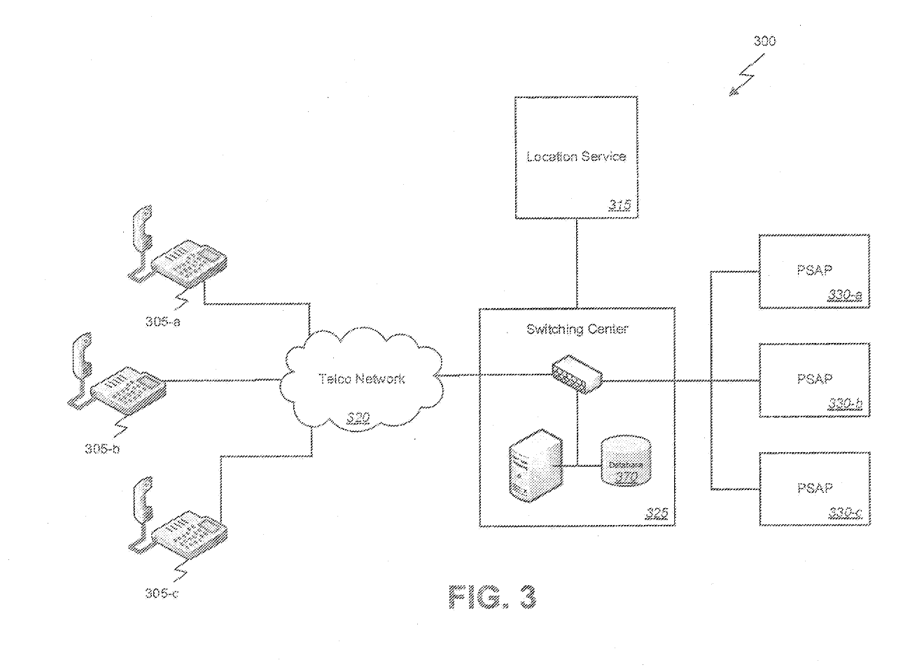

FIG. 3 is a block diagram illustrating elements of an exemplary environment in which emergency call handling may be performed and in which embodiments of the present invention may be implemented. As illustrated here, the emergency call handling system 300 may include a number of telephones 305a-c of various types, each associated with a different telephone number. These telephones 305a-c may be communicatively coupled with a telephone network 320 sending and receiving calls, including but not limited to emergency calls, e.g., 911 calls. For example, the system 300 may also include a switching center 325 that may also be communicatively coupled with the telephone network 320. As known in the art, the switching center 325 may receive and route calls and other communications to and from telephones 305. In the case of an emergency call, the switching center 325 may determine which of any number of Public Safety Answering Points (PSAPs) 330a-c the call should be routed to based, for example, on the location of the caller and a defined geographic area for which the PSAP 330 is responsible. Generally speaking, this routing can be based on a set of information maintained in a database 370 within the switching center 325 or elsewhere and accessible by the switching center 325. This set of information can include an indication of an address associated with each of a set of telephone numbers and may be referenced by the switching center 325 when routing an emergency call from one of the telephones 305 to one of the PSAPs 330 as known in the art.

According to one embodiment, when an emergency call from a telephone number without an associated address in this database is received, a location service 315 may be used to identify a location for that calling number. For example, this location service 315 may comprise a Local Exchange Routing Guide (LERG) service. In such cases, the switching center 325 can provide all or a portion of the calling number, e.g., the area code and exchange number (NPA-NXX numbers), to the location service which can return a set of Vertical and Horizontal (V&H) coordinates for that calling number. The switching center 325 can then use the V&H coordinates to derive a spatial location, e.g., expressed as a latitude and longitude, for the calling number. The spatial location can then used with a point-in-polygon check by the switching center 325 to determine the PSAP 330 that should receive the call. In other words, embodiments of the present invention are spatial in nature versus a tabular lookup. In addition, embodiments make use of Local Routing Numbers (LRN) to determine the geographic location of a caller who may have ported their number from a different geographic location.

In summary and according to one embodiment, LERG data or similar information from another location service 315 can be used as a source for location information of switches of the telephone network 320 used for particular NPA-NXX numbers, e.g., the V&H coordinates associated with those switches. Known algorithms can be used to convert the V&H coordinates to a latitude and longitude which can then be stored by the switching center 325 in a relational database 370 with the NPA-NXX and switch id. This places the Local Routing Number (LRN) identified by that NPA-NXX spatially. The LRN can be used for ported numbers to determine which telephone switch the call actually came from. When a call is received by the switching center 325, the switching center 325 can use the calling number Automatic Number Identification (ANI) to query the database 325. If the data contains an LRN for the ANI, the LRN can be used as a key in the dataset to look up the telephone network switch and the associated spatial location for that switch since the spatial location of the switch may be derived from the switch identifier. If the data does not contain an LRN for that ANI, the ANI NPA-NXX can be used by the switching center 325 to obtain a location for the switch from the location service 315. Using the obtained location of the telephone network switch, the switching center 325 can determine the associated latitude and longitude and perform a point-in-polygon check to determine the PSAP 330 to which the call should be routed.

Stated another way, the switching center 325 can register a spatial location of each of a plurality of telephone network 320 switches. Generally speaking, the switching center 325 can register a spatial location of each of a plurality of telephone network 320 switches by creating records for each of the switches which identify the switch and storing in the record for that switch an indication, e.g., a latitude and longitude, of a spatial location for that switch. More specifically, registering the spatial location of each of the plurality of telephone network switches can comprise the switching center 325 determining the physical location using an NPA-NXX number for each switch to look up a known physical location for the switch, e.g., V and H coordinates from a Local Exchange Routing Guide (LERG) service or other location service 315. The determined physical location of each of the plurality of telephone network switches can then be converted by the switching center 325 to a spatial location, e.g., V and H coordinates obtained from a LERG service can be converted to latitude-longitude coordinates using known methods. The spatial location for each of the plurality of telephone network switches can then be stored by the switching center 325 in a database 370. For example, storing the spatial location for each of the plurality of telephone network switches comprises storing the set of latitude-longitude coordinates, the NPA-NXX number, and a switch identifier for each switch.

At some point in time, an emergency call can be received by the switching center 325 from a calling number. The switching center 325 can then make a determination as to whether the calling number has been ported from an original geographic location to a new geographic location. Generally speaking, this determination can comprise the switching center 325 querying the database 370 of routing numbers using the calling number. For example, querying the database 370 of routing numbers can comprise using an ANI number of the calling number to look up a LRN for the calling number. The switching center 325 can make a determination of whether the number has been ported based on whether the query returns a routing number associated with the calling number. For example, in response to determining the query does return a routing number associated with the calling number, the calling number can be considered to be ported. In response to the query not returning a routing number associated with the calling number, the calling number can be considered not to be ported.

A spatial location for the calling number can be determined by the switching center 325 based at least in part on whether the calling number has been ported. That is, if calling number is known to have been ported from another geographic location to its current, actual location, the registered information can be used by the switching center 325 in determining a location for the calling number. Otherwise, if the calling number has not been ported, other methods can be used by the switching center 325 to determine the spatial location of the calling number. For example, determining the physical location for the switch associated with the emergency call can comprise the switching center 325 using an NPA-NXX number for the calling number to look up a known physical location for the telephone network 320 switch associated with the emergency call. Once obtained, the determined physical location of the telephone network switch associated with the emergency call can be converted by the switching center 325 to a spatial location, e.g., V and H coordinates obtained from a LERG service or other location service 315 can be converted by the switching center 325 to latitude-longitude coordinates using known methods.

Once the spatial location of the calling number has been determined, a public safety system for handling the emergency call can be identified by the switching center 325 based on the determined spatial location for the calling number. For example, identifying the public safety system for handling the emergency call can comprise the switching center 325 using a point-in-polygon check of the determined spatial location for the calling number against known spatial boundaries for a set of PSAPs 330, e.g., based on longitude and latitude coordinates for each. Once a PSAP 330 for handling the call has been identified, the emergency call can be routed by the switching center 325 to the identified PSAP 330.

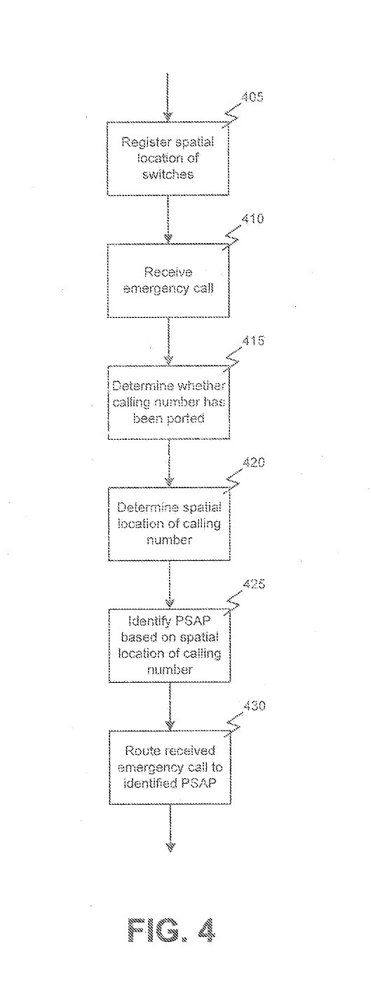

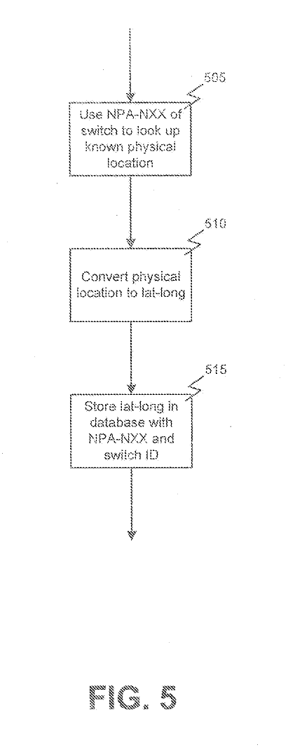

FIG. 4 is a flowchart illustrating a process for handling an emergency call according to one embodiment of the present invention. As illustrated in this example, handling an emergency call can comprise registering 405 a spatial location of each of a plurality of telephone network switches. Generally speaking, registering 405 a spatial location of each of a plurality of telephone network switches can comprise creating records for each of the switches which identify the switch and storing in the record for that switch an indication, e.g., a latitude and longitude, of a spatial location for that switch. Such registration 405 may be performed or updated periodically, upon request, upon detection of a change in the network, or based on other conditions or criteria. Additional details of an exemplary process for registering 405 these locations will be described below with reference to FIG. 5.

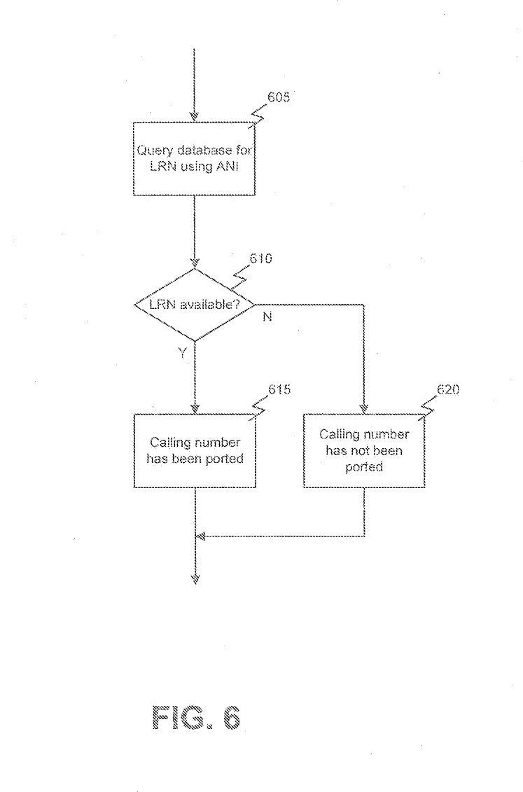

At some point in time, an emergency call can be received 410 from a calling number. A determination 415 can be made as to whether the calling number has been ported from an original geographic location to a new geographic location. Generally speaking, this determination 415 can comprise checking for whether the calling number is known to have been ported from another geographic location to its current, actual location such that telephone network information and the registered 405 information can be considered in determining a location for the calling number. Additional details of an exemplary for determining 415 whether a calling number has been ported will be described below with reference to FIG. 6.

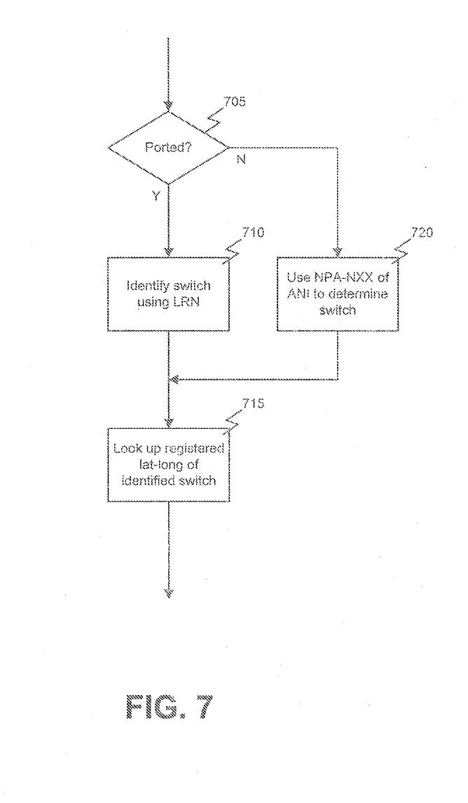

Once it is determined 415 whether the calling number has been ported or has not been ported, a spatial location for the calling number can be determined 420 based at least in part on whether the calling number has been ported. That is, if calling number is known to have been ported from another geographic location to its current, actual location, the registered 405 information can be used in determining 415 a location for the calling number. Otherwise, if the calling number has not been ported, other methods can be used to determine 415 the spatial location of the calling number. Additional details of an exemplary process for determining 420 a spatial location for the calling number will be described below with reference to FIG. 7.

Once the spatial location of the calling number has been determined 420, a public safety system for handling the emergency call can be identified 425 based on the determined spatial location for the calling number. For example, identifying 425 the public safety system for handling the emergency call can comprise using a point-in-polygon check of the determined spatial location for the calling number against known spatial boundaries for a plurality of public safety systems, e.g., based on longitude and latitude coordinates for each. Once an public safety system for handling the call has been identified 425, the emergency call can be routed 430 to the identified public safety system.

FIG. 5 is a flowchart illustrating an exemplary process for registering a spatial location for a telephone network switch according to one embodiment of the present invention. As introduced above, registering 405 a spatial location of each of a plurality of telephone network switches can comprise creating records for each of the switches which identify the switch and storing in the record for that switch an indication, e.g., a latitude and longitude, of a spatial location for that switch More specifically and as illustrated in this example, registering 405 the spatial location of each of the plurality of telephone network switches can comprise determining 505 a physical location for each of the plurality of telephone network switches. Determining 505 the physical location can comprise using an NPA-NXX number for each switch to look up a known physical location for the switch, e.g., V and H coordinates from a Local Exchange Routing Guide (LERG) database.

The determined physical location of each of the plurality of telephone network switches can then be converted 510 to a spatial location. Converting 510 the determined physical location of each of the plurality of telephone network switches to a spatial location can comprise converting the physical location of each switch to a set of latitude-longitude coordinates. For example, V and H coordinates obtained from a LERG database can be converted to latitude-longitude coordinates using known methods.

The spatial location for each of the plurality of telephone network switches can then be stored 515. For example, storing 515 the spatial location for each of the plurality of telephone network switches comprises storing the set of latitude-longitude coordinates, the NPA-NXX number, and a switch identifier for each switch. Additional or alternative content for these records is contemplated and considered to be within the scope of the present invention.

FIG. 6 is a flowchart illustrating an exemplary process for determining whether a calling number making an emergency call has been ported according to one embodiment of the present invention. As introduced above, when handling an emergency call, a determination 415 can be made as to whether the calling number has been ported from an original geographic location to a new geographic location. As illustrated in this example, determining 415 whether the calling number has been ported can comprise querying 605 a database of routing numbers using the calling number. For example, querying 605 the database of routing numbers can comprise using an Automatic Number Identification (ANI) number of the calling number to look up a Local Routing Number (LRN) for the calling number.

A determination 610 can be made as to whether the querying 605 returns a routing number associated with the calling number. In response to determining 610 the querying does return a routing number associated with the calling number, the calling number can be determined 615 as having been ported. In response to determining 610 the querying does not return a routing number associated with the calling number, the calling number can be determined 620 as not having been ported.

FIG. 7 is a flowchart illustrating an exemplary process for determining a spatial location for a calling number making an emergency call according to one embodiment of the present invention. As introduced above in describing FIG. 4, once it is determined 415 whether the calling number has been ported or has not been ported, a spatial location for the calling number can be determined 420 based at least in part on whether the calling number has been ported. That is, if the calling number is known to have been ported from another geographic location to its current, actual location, the registered 405 information can be used in determining 415 a location for the calling number.

More specifically and as illustrated in FIG. 7, in response to determining 705 the calling number has been ported a telephone network switch associated with the calling number can be identified 710 using the routing number and the registered spatial location for the identified switch associated with the calling number can be retrieved 715 for use in identifying a public safety system for handling the emergency call. In response to determining 705 the calling number has not been ported, a telephone network switch associated with the emergency call can be determined 720. For example, determining 720 the switch associated with the emergency call can comprise using an NPA-NXX number of the ANI for the calling number to look up the telephone network switch associated with the emergency call. Once determined, the registered spatial location for the determined switch associated with the calling number can be retrieved 715 for use in identifying a public safety system for handling the emergency call.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method for handling an emergency call, the method comprising:
receiving an emergency call from a calling number;
determining whether the calling number has been ported from an original geographic location to a new geographic location;
determining a spatial location for the calling number based at least in part on whether the calling number has been ported;
identifying a public safety answering point (PSAP) for handling the emergency call based on the determined spatial location for the calling number; and
routing the emergency call to the identified PSAP.

2. The method of claim 1, further comprising, prior to receiving the emergency call, registering a spatial location of each of a plurality of telephone network switches, the registering comprising:
determining a spatial location for each of the plurality of telephone network switches based on a known physical location; and
storing the spatial location for each of the plurality of telephone network switches.

3. The method of claim 2, wherein determining the physical location comprises using an NPA-NXX number for each switch to look up a known physical location for the switch.

4. The method of claim 3, wherein converting the determined physical location of each of the plurality of telephone network switches to a spatial location comprises converting the physical location of each switch to a set of latitude-longitude coordinates.

5. The method of claim 4, wherein storing the spatial location for each of the plurality of telephone network switches comprises storing the set of latitude-longitude coordinates, the NPA-NXX number, and a switch identifier for each switch.

6. The method of claim 2, wherein determining whether the calling number has been ported comprises:
querying a database of routing numbers using the calling number;
determining the calling number as having been ported when the querying returns a routing number associated with the calling number; and
determining the calling number as not having been ported when the querying does not return a routing number associated with the calling number.

7. The method of claim 6, wherein querying the database of routing numbers comprises using an Automatic Number Identification (ANI) number of the calling number to look up a Local Routing Number (LRN) for the calling number.

8. The method of claim 6, wherein determining the spatial location for the calling number further comprises, in response to determining the calling number has been ported:
identifying a telephone network switch associated with the calling number using the routing number; and
retrieving the registered spatial location for the identified switch associated with the calling number.

9. The method of claim 6, wherein determining the spatial location for the calling number further comprises, in response to determining the calling number has not been ported:
determining a physical location for a telephone network switch associated with the emergency call;
converting the determined physical location of the telephone network switch associated with the emergency call to a spatial location.

10. The method of claim 9, determining the physical location comprises using an NPA-NXX number for the calling number to look up a known physical location for the telephone network switch associated with the emergency call.

11. The method of claim 10, wherein converting the determined physical location of the telephone network switch associated with the emergency call to a spatial location comprises converting the physical location for the telephone network switch associated with the emergency call to a set of latitude-longitude coordinates.

12. The method of claim 1, wherein identifying the PSAP for handling the emergency call comprises using a point-in-polygon check of the determined spatial location for the calling number against known spatial boundaries for a plurality of PSAPs.

13. A system comprising:
a processor; and
a memory coupled with and readable by the processor and storing therein a set of instructions which, when executed by the processor, causes the processor to handle an emergency call by:
receiving an emergency call from a calling number;
determining whether the calling number has been ported from an original geographic location to a new geographic location;
determining a spatial location for the calling number based at least in part on whether the calling number has been ported;
identifying a public safety answering point (PSAP) for handling the emergency call based on the determined spatial location for the calling number; and
routing the emergency call to the identified PSAP.

14. The system of claim 13, further comprising, prior to receiving the emergency call, registering a spatial location of each of a plurality of telephone network switches, wherein registering the spatial location of each of the plurality of telephone network switches comprises:
determining a spatial location for each of the plurality of telephone network switches based on a known physical location; and
storing the spatial location for each of the plurality of telephone network switches.

15. The system of claim 14, wherein determining the physical location comprises using an NPA-NXX number for each switch to look up a known physical location for the switch, wherein
converting the determined physical location of each of the plurality of telephone network switches to a spatial location comprises converting the physical location of each switch to a set of latitude-longitude coordinates, and
storing the spatial location for each of the plurality of telephone network switches comprises storing the set of latitude-longitude coordinates, the NPA-NXX number, and a switch identifier for each switch.

16. The system of claim 14, wherein determining whether the calling number has been ported comprises:
querying a database of routing numbers using the calling number;
determining the calling number as having been ported when the querying returns a routing number associated with the calling number; and
determining the calling number as not having been ported when the querying does not return a routing number associated with the calling number.

17. The system of claim 16, wherein querying the database of routing numbers comprises using an Automatic Number Identification (ANI) number of the calling number to look up a Local Routing Number (LRN) for the calling number.

18. The system of claim 16, wherein determining the spatial location for the calling number further comprises, in response to determining the calling number has been ported:
identifying a telephone network switch associated with the calling number using the routing number; and
retrieving the registered spatial location for the identified switch associated with the calling number.

19. The system of claim 18, wherein determining the spatial location for the calling number further comprises, in response to determining the calling number has not been ported:
determining a physical location for a telephone network switch associated with the emergency call;
converting the determined physical location of the telephone network switch associated with the emergency call to a spatial location.

20. The system of claim 19, wherein
determining the physical location comprises using an NPA-NXX number for the calling number to look up a known physical location for the telephone network switch associated with the emergency call, and
converting the determined physical location of the telephone network switch associated with the emergency call to a spatial location comprises converting the physical location for the telephone network switch associated with the emergency call to a set of latitude-longitude coordinates.

21. The system of claim 13, wherein identifying the PSAP for handling the emergency call comprises using a point-in-polygon check of the determined spatial location for the calling number against known spatial boundaries for a plurality of PSAPs.

22. A computer-readable memory comprising a set of instructions stored therein which, when executed by a processor, causes the processor to handle an emergency call by:
receiving an emergency call from a calling number;
determining whether the calling number has been ported from an original geographic location to a new geographic location;
determining a spatial location for the calling number based at least in part on whether the calling number has been ported;
identifying a public safety answering point (PSAP) for handling the emergency call based on the determined spatial location for the calling number; and
routing the emergency call to the identified public safety system.

23. The computer-readable memory of claim 22, further comprising, prior to receiving the emergency call, registering a spatial location of each of a plurality of telephone network switches, wherein registering the spatial location of each of the plurality of telephone network switches comprises:
determining a spatial location for each of the plurality of telephone network switches based on a known physical location; and
storing the spatial location for each of the plurality of telephone network switches.

24. The computer-readable memory of claim 23, wherein
determining the physical location comprises using an NPA-NXX number for each switch to look up a known physical location for the switch,
converting the determined physical location of each of the plurality of telephone network switches to a spatial location comprises converting the physical location of each switch to a set of latitude-longitude coordinates, and
storing the spatial location for each of the plurality of telephone network switches comprises storing the set of latitude-longitude coordinates, the NPA-NXX number, and a switch identifier for each switch.

25. The computer-readable memory of claim 23, wherein determining whether the calling number has been ported comprises:
querying a database of routing numbers using the calling number;
determining the calling number a having been ported when the querying returns a routing number associated with the calling number; and
determining the calling number as not having been ported when the querying does not return a routing number associated with the calling number.

26. The computer-readable memory of claim 25, wherein querying the database of routing numbers comprises using an Automatic Number Identification (ANI) number of the calling number to look up a Local Routing Number (LRN) for the calling number.

27. The computer-readable memory of claim 25, wherein determining the spatial location for the calling number further comprises, in response to determining the calling number has been ported:
identifying a telephone network switch associated with the calling number using the routing number; and
retrieving the registered spatial location for the identified switch associated with the calling number.

28. The computer-readable memory of claim 27, wherein determining the spatial location for the calling number further comprises, in response to determining the calling number has not been ported:
determining a physical location for a telephone network switch associated with the emergency call; and
converting the determined physical location of the telephone network switch associated with the emergency call to a spatial location.

29. The computer-readable memory of claim 28, wherein
determining the physical location comprises using an NPA-NXX number for the calling number to look up a known physical location for the telephone network switch associated with the emergency call, and
converting the determined physical location of the telephone network switch associated with the emergency call to a spatial location comprises converting the physical location for the telephone network switch associated with the emergency call to a set of latitude-longitude coordinates.

30. The computer-readable memory of claim 22, wherein identifying the PSAP for handling the emergency call comprises using a point-in-polygon check of the determined spatial location for the calling number against known spatial boundaries for a plurality of PSAPs.
